(19) United States
(12) Patent Application Publication
(10) Pub. No.: US 2010/0209565 A1
(43) Pub. Date: Aug. 19, 2010

(54) BEVERAGE PACKED IN CONTAINER

(75) Inventors: Yoko Sugiura, Tokyo (JP); Yoshikazu Ogura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kao Corporation, Tokyo (JP)

(21) Appl. No.: 12/738,726

(22) PCT Filed: Sep. 25, 2008
(86) PCT No.: PCT/JP2008/002653

§ 371 Date: Apr. 19, 2010

(30) Foreign Application Priority Data
Oct. 22, 2007 (JP) 2007-273809

(51) Int. Cl. A23L 2/52; B65D 85/72

(52) U.S. Cl. 426/130; 426/106

(57) ABSTRACT

The present invention is related to a packed beverage containing potassium alginate and having a pH of 3.1 or higher, wherein the beverage has an alginic acid content of 0.3 to 8 mass % and a potassium content of 0.05 to 2.6 mass %, and the potassium content satisfies the formula 1:

(0.85×alginic acid mass %)^{0.5}≧potassium mass % (1).

The present invention provides a packed beverage for potassium intake, which has a reduced bitter/salty taste intrinsic to potassium and reduced lingering aftertaste and which has an excellent flavor.

### FIELD OF THE INVENTION

The present invention relates to a packed beverage containing potassium alginate.

### BACKGROUND OF THE INVENTION

In recent years, prevention of lifestyle-related diseases has become a big issue. Some studies have revealed that increase in potassium intake leads to lowered blood pressure, prevention of cerebral stroke, and increased bone density. According to “The Dietary Reference Intakes for Japanese (2005 edition)” settled by the Ministry of Health, Labour and Welfare, the desired amount of potassium intake is determined as 3,500 mg/day for preventing lifestyle-related diseases. However, the actual average amount of potassium intake is about 2,300 mg/day, which is smaller than the desired amount by about 1,000 mg/day. In order to remedy this situation, there has been a demand for the development of food which realizes easy and convenient potassium intake.

Many of the existing foods designed to supply potassium and other minerals employ, as a potassium source, potassium carbonate, potassium chloride or a similar compound. Therefore, when a large amount of potassium is incorporated into a food for high concentration of potassium intake, the food exhibits a strong bitter/salty taste intrinsic to potassium and strong lingering aftertaste, which problematically impair the taste of the food. One possible solution to the problem is a beverage and a jelly containing trehalose, by which the salty taste and bitter taste attributed to minerals are reduced (Patent Document 1). There has been reported a food for suppressing blood pressure increase, containing potassium alginate oligosaccharide (Patent Document 2). There has also been reported a potassium-supplying preparation containing a certain percentage of a magnesium-containing compound as an essential ingredient, which preparation contains further potassium alginate as a potassium-containing compound (Patent Document 3).

### Patent Document 1: JP-A-H11-89547

### Patent Document 2: JP-A-H06-237783

### Patent Document 3: JP-A-H03-128325

### SUMMARY OF THE INVENTION

The present invention provides a packed beverage containing potassium alginate and having a pH of 3.1 or higher, characterized in that the beverage has an alginic acid content of 0.3 to 8 mass % and a potassium content of 0.05 to 2.6 mass %, and the potassium content satisfies the following formula 1:

(0.85×alginic acid mass %)^{0.5}≧potassium mass % (1).

### BRIEF DESCRIPTION OF THE DRAWINGS

FIG. 1 A graph showing the relationship between the alginic acid content and the potassium content of a beverage.

### DETAILED DESCRIPTION OF THE INVENTION

A conventional taste-masking technique based on employment of sole saccharides such as trehalose has a limitation due to difficulty in controlling sweetness. Thus, such a technique has left room for improvement. Meanwhile, potassium alginate oligosaccharide having a small polymerization degree of 2 to 5 (molecular weight: about 414 to about 1,062) poses a problem in that it readily causes osmotic diarrhea when taken at a high concentration. Another technique in which intake of potassium into cells is promoted by magnesium can be applied to a solid (e.g. tablets) without any problem, but poses a problem of poor storage stability when magnesium and potassium are present together in an aqueous solution.

Thus, the present invention is to provide a packed beverage for potassium intake, which reduces a bitter/salty taste intrinsic to potassium and lingering aftertaste and which has an excellent flavor.

The present inventors have conducted extensive studies for solving the aforementioned problems, and have found that alginic acid improves the taste of potassium-containing solution under specific pH conditions. That is, the inventors have found that, through controlling the potassium content and pH of a beverage containing a specific amount of potassium alginate, a bitter/salty taste intrinsic to potassium in the beverage and lingering aftertaste can be reduced.

Although the packed beverage of the present invention has a relatively high potassium concentration, a bitter/salty taste intrinsic to potassium and lingering aftertaste can be suppressed. Thus, the beverage of the present invention serves as a packed beverage for potassium intake having an excellent flavor.

Characteristic features of the packed beverage of the present invention reside in that the beverage contains potassium alginate and has a potassium content as high as 0.05 to 2.6 mass, that the pH of the beverage is adjusted to 3.1 or higher, and that the alginic acid content and the potassium content satisfy the aforementioned formula 1.

Quite surprisingly, such a packed beverage exhibits a reduced bitter/salty taste intrinsic to potassium and reduced lingering aftertaste. It is conceivable that since potassium ions are present in the vicinity of the dissociated monosaccharide composing alginic acid at pH of 3.1, it becomes insensitive to the bitter taste as sense of taste.

The beverage of the present invention has a pH of 3.1 or higher, preferably 3.5 or higher, more preferably 3.6 or higher. When the beverage (solution) has a pH of 3.1 or higher, the effect of suppressing a bitter/salty taste intrinsic to potassium can be satisfactorily attained. Furthermore, from the viewpoints of effectively attaining the bitter/salty taste masking effect by an acidic taste and improving the taste of the beverage, the pH is preferably 7 or lower, more preferably 5.1 or lower, even more preferably 4.6 or lower, even more preferably 4.4 or lower.

For the aforementioned adjustment of pH, the packed beverage of the present invention may contain an edible organic or inorganic acid. No particular limitation is imposed on the edible acid, and any edible acid may be used so long as the acid can be generally employed in food. Examples of the edible acid include lactic acid, citric acid, tartaric acid, malic acid, ascorbic acid, acetic acid, fumaric acid, phosphoric acid, adipic acid, gluconic acid, succinic acid, potassium or sodium hydrogenphosphate, potassium or sodium dihydrogenphosphate, and fruit juice. Of these, lactic acid, citric acid, tartaric acid, malic acid, ascorbic acid, and acetic acid are preferred, from the viewpoint of sour taste.

From the viewpoints of use of the beverage as that for potassium intake and the oral sensation of the beverage, the packed beverage of the present invention has a potassium concentration of 0.05 mass % or higher, preferably 0.06 mass % or higher, more preferably 0.07 mass % or higher, even more preferably 0.1 mass % or higher, and a potassium concentration of 2.6 mass % or lower, preferably 2 mass % or lower, more preferably 1.8 mass % or lower. When the packed beverage has such a potassium concentration, the volume required for intake of 1,000 mg of potassium is about 40 mL to about 2,000 mL, which is suited for daily consumption of a single portion or for daily consumption divided into several portions.

The alginic acid concentration of the packed beverage of the present invention is 0.3 mass % or higher, preferably 0.5 mass % or higher, more preferably 0.8 mass % or higher, even more preferably 1.0 mass % or higher, from the viewpoint of the effect of suppressing the bitter/salty taste intrinsic to potassium and lingering aftertaste. From the viewpoints of preventing an excessive increase in viscosity of the beverage and mitigating lingering aftertaste on the tongue to improve aftertaste, the alginic acid concentration is 8 mass % or lower, preferably 5 mass % or lower, more preferably 4.5 mass % or lower.

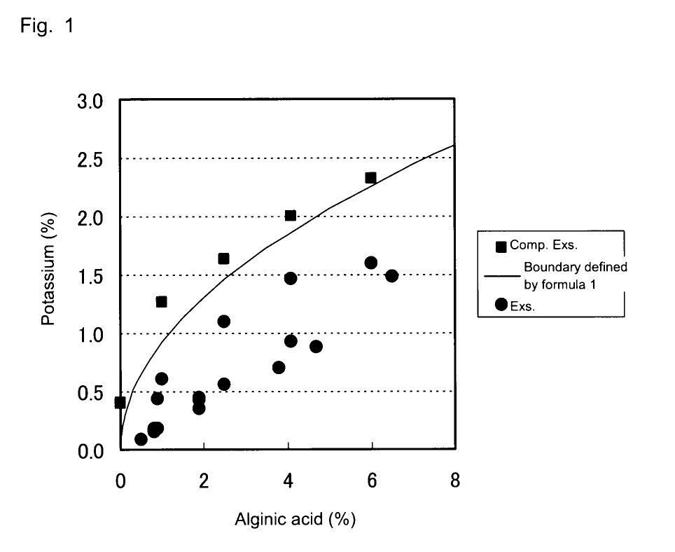

From the viewpoint of the effect of potassium alginate on suppression of a bitter/salty taste intrinsic to potassium and lingering aftertaste, the alginic acid content and potassium content of the packed beverage of the present invention satisfy the aforementioned formula 1. That is, when the formula 1: (0.85×alginic acid mass %)^{0.5}≧potassium mass % is satisfied, the bitter/salty taste intrinsic to potassium and lingering aftertaste are suppressed (see FIG. 1).

Formula (1) means that a certain minimum amount by mass of alginic acid is required, with respect to the mass of potassium, for attaining the effects of the present invention. The reason for absence of the proportional relationship between the alginic acid content and the potassium content has not been clearly elucidated. However, one conceivable reason is that the sense of taste is not proportional to the amount of a stimulating substance. Through allowing the potassium amount (mass %) to fall within a range defined by formula 1, in the beverage of the invention having a pH of 3.1 or higher, a satisfactory effect of suppressing a bitter/salty taste intrinsic to potassium can be attained.

The potassium content of the packed beverage of the present invention preferably falls within a range defined by formula 2: (0.80×alginic acid mass %)^{0.5}≧potassium mass %, more preferably within a range defined by formula 3: (0.60×alginic acid mass %)^{0.5}≧potassium mass %.

When the packed beverage of the present invention has an alginic acid content of 0.3 mass % or higher and lower than 1 mass %, the potassium content is preferably 0.5 mass % or lower. When the alginic acid content is 1 mass % or higher and lower than 2 mass %, the potassium content is preferably 0.9 mass % or lower. When the alginic acid content is 2 mass % or higher and lower than 4 mass %, the potassium content is preferably 1.3 mass % or lower. When the alginic acid content is 4 mass % or higher and lower than 6 mass %, the potassium content is preferably 1.8 mass % or lower. When the alginic acid content is 6 mass % or higher and lower than 8 mass %, the potassium content is preferably 2.2 mass % or lower.

For preventing osmotic diarrhea after intake of potassium, the potassium alginate contained in the packed beverage of the present invention preferably has a molecular weight higher than that of oligosaccharide. For maintaining fluidity of the beverage so as to prevent the bitter/salty taste intrinsic to potassium from lingering on the tongue, the potassium alginate preferably has a molecular weight that is not excessively high. Thus, the molecular weight—the weight average molecular weight as determined through GPC—is preferably 10,000 or more, more preferably 20,000 or more, even more preferably 30,000 or more, and is preferably 900,000 or less, more preferably 100,000 or less, even more preferably 70,000 or less, even more preferably 50,000 or less. Notably, the molecular weight of potassium alginate contained in the beverage may be determined through “quantitation of alginic acid and measurement of weight average molecular weight” mentioned herein below.

The potassium alginate having such a molecular weight may be produced through molecular weight reduction of a high-molecular-weight alginic acid. No particular limitation is imposed on the method of reducing molecular weight, and any methods of hydrolysis in the presence of acid or alkali; biodegradation by use of a degrading enzyme; etc. may be employed. Hydrolysis may be performed under normal pressure or increased pressure.

Examples of the potassium alginate contained in the packed beverage of the present invention include Kimika Algin SKAT-K-ULV (product of Kimika Corporation) and Kali Algin (product of Kibun Food Chemifa Co., Ltd.). However, the potassium alginate is not limited to the above examples.

Preferably, the packed beverage of the present invention contains one or more sweeteners, since presence of the sweetener(s) and alginic acid synergistically suppresses lingering aftertaste intrinsic to potassium. Particularly, when the sum of the products of the degree of sweetness and concentration of the sweeteners is 1 or higher, i.e., when the sum of the products (sweetener concentration (mass %)× the degree of sweetness) of one or more sweeteners contained in the beverage is 1 or higher, not only lingering aftertaste intrinsic to potassium is suppressed but also the effect of strengthening the bitter/salty taste intrinsic to potassium is suppressed, which are preferred. When only one sweetener is used, the sum of the products of the degree of sweetness and the concentration of the sweeteners should represent the “product” of sweetener concentration (mass %) and degree of sweetness. However, in the present invention, the concept “sum of the products” of the degree of sweetness and the concentration of the sweeteners encompasses such a single product.

Particularly when the sum of the products of the degree of sweetness and the concentration of the sweeteners is 15 or lower, the beverage does not have excessive sweetness, and the taste of the beverage is not impaired. In addition, some sweeteners prevent excessive calorie intake. Thus, a sum of 15 or lower is preferred. The sweetener content of the packed beverage of the present invention is set such that lingering aftertaste of potassium alginate can be suppressed, such that the bitter/salty taste intrinsic to potassium alginate is not strengthened, and such that the sweetness of the beverage is not excessive. The sum of the product of the degree of sweetness and the concentration the sweeteners is 1 or higher, preferably 2 or higher, and 15 or lower, preferably 12 or lower, more preferably 10 or lower. As used herein, the term “degree of sweetness (S)” refers to a sweetness index represented by formula 4:

S=10/C (4)

wherein C represents a sweetener concentration (mass %) that provides the same sweetness as that of 10 mass % sucrose solution at room temperature.

No particular limitation is imposed on the sweetener employed in the packed beverage of the present invention, and any sweetener may be used so long as it is generally employed in food. Examples of the sweetener include monosaccharide, oligosaccharide, sugar alcohol, a non-sugar natural sweetener, an amino acid-type sweetener, and a synthetic sweetener. Examples of the monosaccharide include fructose, glucose, galactose, xylose and tagatose. Examples of the oligosaccharide include sucrose, lactose, maltose, trehalose, isomalto-oligosaccharide, galacto-oligosaccharide, fructo-oligosaccharide, lactofructo-oligosaccharide, soybean oligosaccharide, palatinose and coupling sugar. Examples of the sugar alcohol include erythritol, xylitol, maltitol, sorbitol, lactitol and mannitol. Examples of the non-sugar natural sweetener include stevioside, glycyrrhizin and thaumatin. Examples of the amino-acid-type sweetener include aspartame. Examples of the synthetic sweetener include saccharin, sucralose and acesulfam potassium. As these sweeteners, a commercially available sweetener may be incorporated into the packed beverage of the present invention. Alternatively, fruit juice, vegetable juice, honey, etc. each containing monosaccharide or disaccharide may also be employed as sweeteners.

The degree of sweetness of each of the above sweeteners is shown in Table 1. Needless to say, sweeteners other than those listed in Table 1 may be incorporated into the packed beverage of the present invention. In this case, the values generally known as the degree of sweetness of those sweetener with respect to the 1 of that of sucrose are applied thereto. The sweeteners may be used in combination of a plurality of species. In this case, the sum of the products of the degree of sweetness and the concentration of all the sweeteners preferably falls within the aforementioned ranges.

TABLE 1
The degree of sweetness of Sweetener to 1 of sucrose

| | | Degree of |
|---|---|---|
| Class | Sweetener | Sweetness |
| Monosaccharide | Fructose | 1.5 |
| | Glucose | 0.5 |
| | galactose | 0.3 |
| | Xylose | 0.4 |
| | Tagatose | 0.9 |
| Oligosaccharide | Sucrose | 1.0 |
| | Lactose | 0.2 |
| | Maltose | 0.4 |
| | Trehalose | 0.5 |
| | Isomalto-oligosaccharide | 0.6 |
| | Galacto-oligosaccharide | 0.3 |
| | Fructo-oligosaccharide | 0.5 |
| | Lactofructo-oligosaccharide | 0.7 |
| | Soybean oligosaccharide | 0.8 |
| | Palatinose | 0.4 |
| | Coupling sugar | 0.5 |
| Sugar alcohol | Erythritol | 0.7 |
| | Xylitol | 1.0 |
| | Maltitol | 0.9 |
| | Sorbitol | 0.6 |
| | Lactitol | 0.4 |
| | Mannitol | 0.6 |
| Non-sugar natural | Stevioside | 300 |
| sweetener | Glycyrrhizin | 200 |
| | Thaumatin | 3,000 |
| Amino acid-type sweetener | Aspartame | 200 |
| Synthetic sweetener | Saccharin | 500 |
| | Sucralose | 600 |
| | Acesulfam potassium | 200 |

The packed beverage of the present invention encompasses beverages having a wide range of fluidity; i.e., from high-fluidity products such as near-water beverages to low-fluidity products such as jelly. The packed beverage of the present invention may contain appropriate additives such as a colorant, an anti-oxidant, a flavor, an emulsifier, a preservative, fruit juice, and a milk component. Fruit juice is not necessarily added to the beverage of the invention. When fruit juice is added to the beverage, the fruit juice content of the packed beverage is preferably 12 mass % or less (as calculated based on straight juice content), more preferably 10 mass % or less, even more preferably 6 mass % or less. From the viewpoint of flavor of the fruit juice, the fruit juice content is preferably 0.1 mass % or more, more preferably 0.5 mass % or more. When a milk component is added to the beverage, the solid-non-fat content is preferably adjusted to 0.1 mass % to 8 mass %.

No particular limitation is imposed on the method of producing the packed beverage of the present invention, and the beverage may be produced through a conventional method, which includes a step of dissolving potassium alginate, a step of mixing the dissolved potassium alginate with other ingredients, and a sterilizing/packing step. Dissolving of potassium alginate may be performed at normal temperature or elevated temperature. The dissolving temperature is preferably 50 to 80° C., more preferably 55 to 70° C. In order to enhance the effect of preventing coagulation and precipitation, an emulsifying apparatus such as a homogenizer may be used. No particular limitation is imposed on the sterilization conditions for the beverage of the present invention, so long as the conditions meet those stipulated by the Food Sanitation Law. No particular limitation is imposed on the sterilization means, and a variety of sterilization apparatus such as a retort, UHT, and HTST may be employed. No particular limitation is imposed on the container packing method carried out after sterilization, and hot-pack filling (hot filling), aseptic filling, etc. may be employed. No particular limitation is imposed on the container of the beverage of the present invention, and any container may be used so long as it is generally employed as a beverage container. Examples of the container include a PET bottle, a metallic can, a cheer pack, and a paper container.

### EXAMPLES

### Method for Evaluation of Bitter/Salty Taste and Lingering Aftertaste and Ratings of Evaluation

Packed beverages for the present invention of Examples and those for Comparative Examples were prepared. Each of the beverages was stored at 5° C. with the container being in an inverted upright posture. After elapse of 24 hours, the beverage was well shaken, and one expert panel evaluated the taste on the basis of the following ratings.

Bitter/salty taste: strong (5), somewhat strong (4), somewhat weak (3), weak (2), and virtually insensible (1) Lingering aftertaste: strong (5), somewhat strong (4), somewhat weak (3), weak (2), and virtually insensible (1)
Method of measuring pH after sterilization Each beverage sample was maintained at 20° C., and the pH thereof was measured by means of a pH meter (F-22) (product of Horiba, Ltd.).

### Quantitation of Alginic Acid and Measurement of Weight Average Molecular Weight

### 1. Preliminary Treatments (Preparation of HPLC Analysis Samples)

### 1-1. Formation of Calcium Alginate Precipitates

A beverage sample (2 g) was added to a beaker, and water (35 mL) was added thereto, followed by stirring to a homogeneous state. To the mixture, 2 mol/L aqueous solution of calcium chloride (1.5 mL) was added dropwise over 5 to 10 minutes, while the mixture was appropriately stirred by means of a vortex mixer. Water (about 5 mL) was further added, as the formed precipitates deposited on the sidewall of the beaker were washed into the beaker. Subsequently, 1 mol/L sodium hydroxide solution was added to adjust the pH to 11 or higher. The solution in the beaker was well mixed and transferred to a 50-mL measuring flask. The precipitates deposited on the inner wall of the beaker were washed off with water and transferred to the measuring flask. The volume of the liquid in the measuring flask was adjusted to 50 mL. After closure of the flask with a stopper, the solution was stirred for 20 seconds by means of a vortex mixer, and the solution was allowed to stand at room temperature for 20 minutes (solution A).

### 1-2. Recovery of Calcium Alginate Precipitates

A membrane filter (diameter: 25 mm) was set in a membrane filter cartridge, and the cartridge was attached to a 5-mL syringe. Then, sufficiently mixed solution A (5 mL) was added to the syringe by means of a whole pipette. Through pushing of the piston attached to the syringe, the solution was filtered through the membrane filter. Thereafter, the substance deposited on the inner wall of the whole pipette and the inner wall of the syringe was washed into the same syringe by use of 40 mmol/L aqueous solution of calcium chloride (pH 11.3 adjusted by sodium hydroxide) (about 3 mL), and filtration was performed through the membrane filter. The washing procedure was repeated once.

### 1-3. Salt Exchange to Sodium Alginate and Recovery of the Product

The membrane filter cartridge which had undergone the aforementioned procedure was broken, and the membrane filter and the packing were collected and placed in a beaker. The remaining parts of the membrane filter cartridge were placed in the beaker as washing with water (4.8 mL). Then, 1.5 mol/L aqueous solution of sodium carbonate (200 μL) was added to the wash liquid, and the mixture was slightly stirred so as to attain a homogeneous state (total volume: about 5 mL). During stirring, shake-admixing was performed thrice, and the mixture was allowed to stand at room temperature for one hour to two hours. Thereafter, the mixture was stirred again, and the entirety thereof was transferred to a 10-mL measuring flask. The parts remaining in the beaker were washed with water (about 5 mL), and the wash liquid was added to the measuring flask. The total volume was adjusted to 10 mL. Through the above steps, alginic acid contained in the beverage was dissolved and recovered as sodium alginate. The solution was filtered through a membrane filter (diameter: 25 mm, GL Chromatodisk 0.45 μm), to thereby provide HPLC analysis samples.

### 2. Quantitation of Alginic Acid

Each HPLC analysis sample (100 μL) was subjected to high-performance liquid chromatography (HPLC). Similarly, a 0.1% sodium alginate solution having a known purity (standard sample) was also subjected to HPLC. Through comparison of the area of the chromatogram of the sample with that of the standard, sodium alginate contained in the sample was quantitated. The alginic acid content of the beverage was calculated through multiplying the quantitated sodium alginate content of the sample by a constant of 0.9. HPLC was performed under the following operational conditions.

HPLC operational conditions

### Column:

(1) Super AW-L (guard column): product of Tosoh Corporation
(2) TSK-GEL Super AW4000 (GPC column):
exclusion limit molecular weight of 4×10⁵ PEO/DMF, length of 15 cm, inner diameter of 6 mm, product of Tosoh Corporation
(3) TSK-GEL Super AW2500 (GPC column):
exclusion limit molecular weight of 2×10³ PEO/DMF, length of 15 cm, inner diameter of 6 mm, product of Tosoh Corporation

The aforementioned columns AW-L, AW4000, and AW2500 are connected in that order.

Column temperature: 40° C.

Detector: differential refractive index detector

Mobile phase: 0.2 mol/L aqueous solution of sodium nitrate

Flow rate: 0.6 mL/min

Injection volume: 100 μL

### 3. Method of Measuring Average Molecular Weight of Alginic Acid (Weight Average Molecular Weight Measuring Method)

The weight average molecular weight of alginic acid was determined through high-performance liquid chromatography (HPLC) under the same HPLC operational conditions as employed in “2. Quantitation of alginic acid.” The calibration curve for calculating molecular weight was drawn by use of standard pullulan (Shodex STANDARD P-82, product of Showa Denko K.K.). An HPLC analysis sample (100 μL) was injected to the aforementioned chromatograph, and the weight average molecular weight of sodium alginate contained in the sample was calculated from the obtained chromatogram. The weight average molecular weight of alginic acid contained in the beverage was determined through multiplying the determined weight average molecular weight of alginic acid contained in the sample, by a constant of 0.9.

### Measuring of Potassium Content

The potassium content was measured in accordance with the descriptions (p. 90 to 91 and p. 99 to 103) of “Guide for ‘Manual for Standard Tables of Food Composition in Japan, Fifth Revised’ written by analysis practitioners” (edited by Japan Food Research Laboratories, printed by Chuohoki Publishers Co., Ltd., Jul. 10, 2001). Specifically, a sample (2 to 5 g) was weighed and placed in an extraction vessel, and 1% HCl solution (200 mL) was added to the vessel. The mixture was shaken at room temperature for 30 minutes for extraction. The extract was transferred to a centrifuge tube, and the supernatant obtained through centrifugation was employed as an atomic absorption test solution. Atomic absorption was measured at 766.5 nm by means of an atomic absorption spectrophotometer, to thereby quantitate potassium.

### Preparation Example 1

### Potassium Alginate Having a Weight Average Molecular Weight of 40,000)

Potassium alginate (SKAT-K-ULV, product of Kimika Corporation) was employed as it is in Examples 1 to 18 and 28, and Comparative Examples 4 to 8.

### Preparation Example 2

### Preparation of Potassium Alginate Having a Weight Average Molecular Weight of 30,000)

Potassium alginate (Kali Algin K-300, product of Kibun Food Chemifa Co., Ltd.) was employed as a starting material and heated under acidic conditions. The product was neutralized with potassium hydroxide and dried, to thereby prepare the potassium alginate, which was employed in Examples 19 to 21, and 25 to 27.

### Preparation Example 3

### Preparation of Potassium Alginate Having a Weight Average Molecular Weight of 20,000)

Potassium alginate (SKAT-K-ULV, product of Kimika Corporation) was employed as a starting material and heated under acidic conditions. The product was neutralized with potassium hydroxide and dried, to thereby prepare the potassium alginate, which was employed in Examples 22 to 24.

Packed beverages having compositions as listed in Tables 2 to 6 were produced. In the beverage production, a specific amount of potassium alginate was dissolved in water (60° C.) by means of a stirrer. If required, potassium chloride, potassium dihydrogenphosphate, or a saccharide was added to the solution and was dissolved at room temperature by means of a stirrer. The pH of the beverage was adjusted with citric acid.

Subsequently, a glass tube equipped with a stopper was filled with the produced beverage, followed by sterilizing at 85° C. for 30 minutes in a thermostat bath (85° C.), to thereby produce a packed beverage.

### Examples 1 and 2, and Comparative Examples 1 to 3

Packed beverages having a potassium content of about 400 mg/100 g were produced.

The beverages of Examples 1 and 2, produced by use of potassium alginate as a potassium source, exhibited a bitter/salty taste rating of weak (2). The beverage of Example 1, containing no sweetener, exhibited a lingering aftertaste rating of weak (2), and the beverage of Example 2, having a sum of the products of the degree of sweetness and the concentration of the sweeteners of 2.1, exhibited a lingering aftertaste rating of virtually insensible (1). In contrast, the beverages of Comparative Examples 1 and 2, produced by use of potassium chloride as a potassium source, exhibited a bitter/salty taste rating and a lingering aftertaste rating of strong (5) or somewhat strong (4). The beverage of Comparative Example 3, produced by use of potassium dihydrogenphosphate as a potassium source, exhibited a bitter/salty taste rating and a lingering aftertaste score of somewhat strong (4).

### Examples 3 to 8, and Comparative Examples 4 to 7

The alginic acid content and potassium content of the beverage were investigated. The sum of the products of the degree of sweetness and the concentration of the sweeteners was adjusted to 4.0 or 8.0. The beverages of Examples 3 to 8, satisfying the relationship between alginic acid content and potassium content represented by formula 1, exhibited a bitter/salty taste rating and a lingering aftertaste rating equivalent to somewhat weak (3) or lower. In contrast, the beverages of Comparative Examples 4 to 7, not satisfying the relationship between alginic acid content and potassium content represented by formula 1, exhibited a bitter/salty taste rating equivalent to somewhat strong (4) or higher, and a lingering aftertaste rating equivalent to somewhat weak (3) or higher.

(0.85×alginic acid mass %)^{0.5}≧potassium mass % (1)

### Examples 9 to 15

Beverages of various combinations of the potassium alginate concentration, pH, and sum of the products of the degree of sweetness and the concentration of the sweetener were investigated. The beverages of Examples 9 to 15 exhibited a bitter/salty taste rating and a lingering aftertaste rating equivalent to somewhat weak (3) or lower.

### Comparative Example 8

A beverage having an excessively low pH was investigated. In Comparative Example 8, the bitter/salty taste score was somewhat weak (3), but the lingering aftertaste rating was somewhat strong (4).

### Examples 16 to 18

Beverages containing a milk component or fruit juice. The beverage of Example 16, having a fermented milk content of 10%, exhibited a bitter/salty taste rating and a lingering aftertaste rating of virtually insensible (1). The beverages of Examples 17 and 18, having a fruit juice content of 10% and 5% respectively, exhibited a bitter/salty taste rating and a lingering aftertaste rating of weak (2) or lower.

### Examples 19 to 28, and Comparative Example 9

Beverages containing potassium alginate having a low molecular weight were investigated. Except the beverage of Comparative Example 9, excellent bitter/salty taste ratings and lingering aftertaste ratings were attained.

FIG. 1 shows the relationship between alginic acid contents and potassium contents of the beverages of the aforementioned Examples and Comparative Examples. As is clear from FIG. 1, beverages containing potassium alginate, and having a pH and the relationship between alginic acid content and potassium content which meet specific conditions were able to reduce the bitter/salty taste intrinsic to potassium and lingering aftertaste, and provide a favorable taste.

TABLE 2

| | Ex. 1 | Ex. 2 | Comp. Ex. 1 | Comp. Ex. 2 | Comp. Ex. 3 |
|---|---|---|---|---|---|
| Potassium alginate (g) | 2.34 | 2.34 | — | — | — |
| Potassium chloride (g) | — | — | 0.74 | 0.75 | — |
| Potassium dihydrogenphosphate (g) | — | — | — | — | 1.35 |
| Glucose•fructose•sucrose | — | 5.3 | — | 5.3 | — |
| (2:1:1 wt. ratio) mixture 40% solution (g) | | | | | |
| Water | balance | balance | balance | balance | balance |
| Total (g) | 100 | 100 | 100 | 100 | 100 |
| Potassium content (mg) | 433 | 433 | 397 | 402 | 397 |
| Alginic acid content (g) | 1.9 | 1.9 | 0 | 0 | 0 |
| Av. mol. wt. of alginic acid | 4 × 10⁴ | 4 × 10⁴ | — | — | — |
| Sum of products of the degree of sweetness and the | 0.0 | 2.1 | 0.0 | 2.1 | 0.0 |
| concentration of sweeteners (%) | | | | | |
| pH | 4.19 | 4.19 | 4.20 | 4.23 | 4.20 |
| Formula 1 satisfied or not | satisfied | satisfied | not | not | not |
| | | | satisfied | satisfied | satisfied |
| Bitter/salty taste | 2 | 2 | 5 | 5 | 4 |
| Lingering after taste | 2 | 1 | 5 | 4 | 4 |

TABLE 3

| | | | Comp. | | |
|---|---|---|---|---|---|
| | Ex. 3 | Ex. 4 | Ex. 4 | Ex. 5 | Ex. 6 |
| Potassium alginate (g) | 3.00 | 3.00 | 3.00 | 5.00 | 5.00 |
| Sucrose•glucose•fructose | 10.0 | 10.0 | 10.0 | 10.0 | 10.0 |
| (2:1:1 wt. ratio) mixture 40% solution (g) | | | | | |
| Potassium chloride (g) | 0.00 | 1.00 | 2.00 | 0.00 | 1.00 |
| Water | balance | balance | balance | balance | balance |
| Total (g) | 100 | 100 | 100 | 100 | 100 |
| Potassium content (mg) | 556 | 1092 | 1628 | 926 | 1462 |
| Alginic acid content (g) | 2.5 | 2.5 | 2.5 | 4.1 | 4.1 |
| Av. mol. wt. of alginic acid | 4 × 10⁴ | 4 × 10⁴ | 4 × 10⁴ | 4 × 10⁴ | 4 × 10⁴ |
| Sum of products of the degree of sweetness and the | 4.0 | 4.0 | 4.0 | 4.0 | 4.0 |
| concentration of sweeteners (%) | | | | | |
| pH | 4.52 | 4.49 | 4.50 | 4.51 | 4.50 |
| Formula 1 satisfied or not | satisfied | satisfied | not | satisfied | satisfied |
| | | | satisfied | | |
| Bitter/salty taste | 2 | 3 | 5 | 2 | 3 |
| Lingering after taste | 1 | 3 | 4 | 2 | 3 |
| | Comp. | | Comp. | | Comp. |
| | Ex. 5 | Ex. 7 | Ex. 6 | Ex. 8 | Ex. 7 |
| Potassium alginate (g) | 5.00 | 1.22 | 1.22 | 7.33 | 7.33 |
| Sucrose•glucose•fructose | 10.0 | 10.0 | 10.0 | 20.0 | 20.0 |
| (2:1:1 wt. ratio) mixture 40% solution (g) | | | | | |
| Potassium chloride (g) | 2.00 | 0.73 | 1.99 | 0.51 | 1.91 |
| Water | balance | balance | balance | balance | balance |
| Total (g) | 100 | 100 | 100 | 100 | 100 |
| Potassium content (mg) | 1998 | 602 | 1261 | 1591 | 2323 |
| Alginic acid content (g) | 4.1 | 1.0 | 1.0 | 6.0 | 6.0 |
| Av. mol. wt. of alginic acid | 4 × 10⁴ | 4 × 10⁴ | 4 × 10⁴ | 4 × 10⁴ | 4 × 10⁴ |
| Sum of products of the degree of sweetness and the | 4.0 | 4.0 | 4.0 | 8.0 | 8.0 |
| concentration of sweeteners (%) | | | | | |
| pH | 4.52 | 4.61 | 4.58 | 4.51 | 4.52 |
| Formula 1 satisfied or not | not | satisfied | not | satisfied | not |
| | satisfied | | satisfied | | satisfied |
| Bitter/salty taste | 5 | 2 | 4 | 3 | 4 |
| Lingering after taste | 4 | 2 | 3 | 2 | 4 |

TABLE 4

| | | | | | | | | Comp. |
|---|---|---|---|---|---|---|---|---|
| | Ex. 9 | Ex. 10 | Ex. 11 | Ex. 12 | Ex. 13 | Ex. 14 | Ex. 15 | Ex. 8 |
| Potassium alginate (g) | 2.29 | 8.00 | 1.15 | 4.60 | 0.57 | 5.76 | 2.30 | 2.30 |
| Sucrose•glucose•fructose | 5.2 | 20.0 | 5.0 | 5.1 | 10.0 | 10.0 | 20.0 | 5.2 |
| (2:1:1 wt. ratio) mixture | | | | | | | | |
| 40% solution (g) | | | | | | | | |
| Water | balance | balance | balance | balance | balance | balance | balance | balance |
| Total (g) | 100 | 100 | 100 | 100 | 100 | 100 | 100 | 100 |
| Potassium content (mg) | 425 | 1482 | 175 | 699 | 87 | 875 | 350 | 350 |
| Alginic acid content (g) | 1.9 | 6.5 | 0.9 | 3.8 | 0.5 | 4.7 | 1.9 | 1.9 |
| Av. mol. wt. of alginic | 4 × 10⁴ | 4 × 10⁴ | 4 × 10⁴ | 4 × 10⁴ | 4 × 10⁴ | 4 × 10⁴ | 4 × 10⁴ | 4 × 10⁴ |
| acid | | | | | | | | |
| Sum of products of the | 2.1 | 20.0 | 2.0 | 2.0 | 4.0 | 4.0 | 8.0 | 2.1 |
| degree of sweetness and | | | | | | | | |
| the concentration of | | | | | | | | |
| sweeteners (%) | | | | | | | | |
| pH | 4.97 | 5.00 | 4.23 | 4.22 | 4.18 | 4.21 | 4.23 | 3.02 |
| Formula 1 satisfied or | satisfied | satisfied | satisfied | satisfied | satisfied | satisfied | satisfied | satisfied |
| not | | | | | | | | |
| Bitter/salty taste | 2 | 3 | 1 | 2 | 1 | 3 | 2 | 3 |
| Lingering after taste | 1 | 3 | 1 | 2 | 1 | 2 | 1 | 4 |

TABLE 5

| | Ex. 16 | Ex. 17 | Ex. 18 |
|---|---|---|---|
| Potassium alginate (g) | 2.30 | 2.30 | 2.30 |
| Sucrose•glucose•fructose | 5.2 | 5.2 | 5.2 |
| (2:1:1 wt. ratio) mixture 40% solution (g) | | | |
| Fermented milk (sugar content: 12%)(g) | 10.0 | — | — |
| Fruit juice | — | 10.1 | 5.1 |
| (grape, peach, apple, orange, | | | |
| grapefruit mixture: sugar content: | | | |
| 10%) (g) | | | |
| Water | balance | balance | balance |
| Total (g) | 100 | 100 | 100 |
| Potassium content (mg) | 430 | 441 | 434 |
| Alginic acid content (g) | 1.9 | 1.9 | 1.9 |
| Av. mol. wt. of alginic acid | 4 × 10⁴ | 4 × 10⁴ | 4 × 10⁴ |
| Sum of products of the degree of sweetness | 3.1 | 3.0 | 2.6 |
| and the concentration of sweeteners (%) | | | |
| pH | 4.30 | 4.31 | 4.30 |
| Formula 1 satisfied or not | satisfied | satisfied | satisfied |
| Bitter/salty taste | 1 | 1 | 2 |
| Lingering aftertaste | 1 | 1 | 1 |

TABLE 6

| | Ex. 19 | Ex. 20 | Ex. 21 | Ex. 22 | Ex. 23 | Ex. 24 |
|---|---|---|---|---|---|---|
| Potassium alginate (g) | 1.00 | 1.00 | 1.00 | 1.00 | 1.00 | 1.00 |
| Potassium chloride (g) | — | — | — | — | — | — |
| Erythritol | — | — | — | — | — | — |
| Sucralose | — | — | — | — | — | — |
| Acesulfam potassium | — | — | — | — | — | — |
| Water | balance | balance | balance | balance | balance | balance |
| Total | 100 | 100 | 100 | 100 | 100 | 100 |
| Potassium content (mg/100 g) | 159 | 153 | 156 | 172 | 175 | 173 |
| Alginic acid content (g) | 0.82 | 0.82 | 0.82 | 0.82 | 0.82 | 0.82 |
| Av. mol. wt. of alginic acid | 3 × 10⁴ | 3 × 10⁴ | 3 × 10⁴ | 2 × 10⁴ | 2 × 10⁴ | 2 × 10⁴ |
| Sum of products of the degree of sweetness | 0.0 | 0.0 | 0.0 | 0.0 | 0.0 | 0.0 |
| and the concentration of sweeteners (%) | | | | | | |
| pH | 5.10 | 4.51 | 3.90 | 5.05 | 4.44 | 3.82 |
| Formula 1 satisfied or not | satisfied | satisfied | satisfied | satisfied | satisfied | satisfied |
| Bitter/salty taste | 1 | 1 | 1 | 2 | 1 | 1 |
| Lingering after taste | 1 | 1 | 1 | 1 | 1 | 1 |

| | | | | | Comp. |
|---|---|---|---|---|---|
| | Ex. 25 | Ex. 26 | Ex. 27 | Ex. 28 | Ex. 9 |
| Potassium alginate (g) | 1.00 | 1.00 | 1.00 | 2.34 | — |
| Potassium chloride (g) | — | — | — | — | 0.75 |
| Erythritol | 1.4 | — | — | — | — |
| Sucralose | — | 0.008 | — | 0.008 | 0.008 |
| Acesulfam potassium | — | — | 0.02 | — | — |
| Water | balance | balance | balance | balance | balance |
| Total | 100 | 100 | 100 | 100 | 100 |
| Potassium content (mg/100 g) | 160 | 156 | 159 | 374 | 400 |
| Alginic acid content (g) | 0.82 | 0.82 | 0.82 | 1.9 | 0.00 |
| Av. mol. wt. of alginic acid | 3 × 10⁴ | 3 × 10⁴ | 3 × 10⁴ | 4 × 10⁴ | — |
| Sum of products of the degree of sweetness and the | 1.0 | 4.8 | 4.0 | 4.8 | 4.8 |
| concentration of sweetener (%) | | | | | |
| pH | 4.47 | 4.48 | 4.48 | 4.45 | 5.25 |
| Formula 1 satisfied or not | satisfied | satisfied | satisfied | satisfied | not |
| | | | | | satisfied |
| Bitter/salty taste | 1 | 1 | 1 | 1 | 5 |
| Lingering after taste | 1 | 1 | 1 | 1 | 4 |

10. A packed beverage comprising potassium alginate and having a pH of 3.1 or higher, wherein the beverage has a potassium content of 0.5 mass % or lower when the beverage has an alginic acid content of 0.3 mass % or higher and lower than 1 mass %; a potassium content of 0.9 mass % or lower when the beverage has an alginic acid content of 1 mass % or higher and lower than 2 mass %; a potassium content of 1.3 mass % or lower when the beverage has an alginic acid content of 2 mass % or higher and lower than 4 mass %; a potassium content of 1.8 mass % or lower when the beverage has an alginic acid content of 4 mass % or higher and lower than 6 mass %; and a potassium content of 2.2 mass % or lower when the beverage has an alginic acid content of 6 mass % or higher and lower than 8 mass %.

1. A packed beverage comprising potassium alginate and having a pH of 3.1 or higher, wherein the beverage has an alginic acid content of 0.3 to 8 mass % and a potassium content of 0.05 to 2.6 mass %, and the potassium content satisfies the following formula 1:
(0.85×alginic acid mass %)^{0.5}≧potassium mass % (1).

2. The packed beverage according to claim 1, which has a pH of 5.1 or lower.

3. The packed beverage according to claim 1, wherein the alginic acid has an average molecular weight, as determined through GPC, of 10,000 to 900,000.

4. The packed beverage according to any one of claims 1 to 3, which further comprises one or more sweeteners.

5. The packed beverage according to any one of claims 1 to 3, which further comprises a fruit juice.

6. The packed beverage according to claim 5, wherein the content of the fruit juice, as calculated based on straight juice content, is 12 mass % or less.

7. The packed beverage according to any one of claims 1 to 3, which further contains a milk component.

8. The packed beverage according to claim 4, which has a sum of products of a degrees and a concentration of the sweeteners of 1 to 15.

9. The packed beverage according to any one of claims 1 to 3, which is prepared by incorporating potassium alginate thereinto.
